(19) United States
(12) Patent Application Publication
(10) Pub. No.: US 2015/0234080 A1
(43) Pub. Date: Aug. 20, 2015

(54) Method of processing marine magnetic data and a processing apparatus for the same

(71) Applicant: Korea Institute of Geoscience and Mineral Resources, Daejeon (KR)

(72) Inventors: Kyong O Kim, Daejeon (KR); Jin Ho Kim, Daejeon (KR); Seong Pil Kim, Daejeon (KR); Gee Soo Kong, Daejeon (KR); Moo Hee Kang, Daejeon (KR); Young Ho Yoon, Daejeon (KR)

(21) Appl. No.: 14/121,039

(22) Filed: Jul. 23, 2014

(30) Foreign Application Priority Data
Feb. 19, 2014 (KR) 10-2014-0019151

(51) Int. Cl. G01V 3/38; G01V 3/15

(52) U.S. Cl. CPC G01V 3/38; G01V 3/15

(57) ABSTRACT

The present invention concerns a method of processing marine data and a processing apparatus for the same. The processing method according to the present invention comprises obtaining a per-profile initial total magnetic anomaly from raw data; obtaining a filtered total magnetic anomaly by filtering out a high-frequency component from the initial total magnetic anomaly; obtaining a reference corrected total magnetic anomaly by correcting the filtered total magnetic anomaly with respect to a reference total magnetic anomaly; and showing a per-profile total magnetic anomaly using the reference corrected total magnetic anomaly.

### CROSS-REFERENCE TO RELATED APPLICATION

This application claims the benefit of Korean Patent Application No. 10-2014-0019151 filed on Feb. 19, 2014, the contents of which are incorporated herein by reference.

### BACKGROUND OF THE INVENTION

1. Field of the Invention

to The present invention concerns a method of processing marine magnetic data Measured using a marine magnetometer and a processing apparatus for the same.

2. Background Information

Acquisition of marine magnetic data is performed using a magnetometer installed in a ship as the ship travels along a predetermined marine pathway. From the raw data, a total magnetic anomaly is obtained that is then put to use for geophysical and geological research.

The raw data contains various noises and errors. To obtain accurate total magnetic anomaly, the noises and errors need to be treated.

If raw data is separated and processed per profile, noise reduction through filtering, enhancement in data quality through comparison with exiting data, ease to rid poor quality data and resultant error reduction may be achieved thus leading to an enhancement in data quality. However, the prior art does not conduct per-profile data processing and thus gives rise to poor quality total magnetic anomaly.

### PRIOR ART DOCUMENT

### Patent Document

Korean Patent No. 1,348,788 (published on Jan. 7, 2014)

U.S. Pat. No. 6,546,344 (issued on Apr. 8, 2003).

### SUMMARY OF THE INVENTION

The present invention has been designed to address the above problems and relates to a method of processing marine magnetic data, using a per-profile data processing scheme and a processing apparatus for the same.

The above-described objects of the present invention are achieved by a method of processing marine magnetic data, the method comprising: obtaining a per-profile initial total magnetic anomaly from raw data; obtaining a filtered total magnetic anomaly by filtering out a high-frequency component from the initial total magnetic anomaly; obtaining a reference corrected total magnetic anomaly by shifting the filtered total magnetic anomaly with respect to a reference total magnetic anomaly; and showing a per-profile total magnetic anomaly using the reference corrected total magnetic anomaly.

Showing the per-profile total magnetic anomaly may include showing at least any one of a water depth, raw data, a signal strength, a position of a profile, and a shape of a profile, together with the per-profile total magnetic anomaly.

The method may further comprise obtaining an edited total magnetic anomaly by editing poor quality data based on at least any one of the shown water depth, raw data, signal strength, position of the profile, and shape of the profile.

The method may further comprise obtaining a cross-over corrected total magnetic anomaly by performing cross-over error correction on the edited total magnetic anomaly.

The method may further comprise obtaining a combined cross-over corrected total magnetic anomaly by combining the cross-over correction total magnetic anomaly with other total magnetic anomaly data and performing cross-over error correction on the combined data.

The above-described objects of the present invention are achieved by a method of processing marine magnetic data, the method comprising: preparing for a reference total magnetic anomaly from existing other data; performing reference correction by comparing a total magnetic anomaly obtained from raw data with the reference total magnetic anomaly; and obtaining a per-profile total magnetic anomaly based on the reference corrected total magnetic anomaly.

Showing the per-profile total magnetic anomaly may include showing at least any one of a water depth, raw data, a signal strength, a position of a profile, and a shape of a profile, together with the per-profile total magnetic anomaly, and the method further comprising: obtaining an edited total magnetic anomaly by editing poor quality data based on at least any one of the shown water depth, raw data, signal strength, position of the profile, and shape of the profile; and obtaining a combined total magnetic anomaly by combining the edited total magnetic anomaly with other total magnetic anomaly data.

The method may further comprise obtaining a final total magnetic anomaly by performing cross-over correction on the combined total magnetic anomaly.

The above-described objects of the present invention are achieved by an apparatus of processing marine magnetic data, the method comprising: an initial total magnetic anomaly obtaining unit obtaining a per-profile initial total magnetic anomaly from raw data; a filtering unit obtaining a filtered total magnetic anomaly by filtering out a high-frequency component from the initial total magnetic anomaly; a shifting unit obtaining a reference corrected total magnetic anomaly by shifting the filtered total magnetic anomaly with respect to a reference total magnetic anomaly; and a per-profile showing unit showing a per-profile total magnetic anomaly using the reference corrected total magnetic anomaly.

The per-profile showing unit may show at least any one of a water depth, raw data, a signal strength, a position of a profile, and a shape of a profile, together with the per-profile total magnetic anomaly.

The apparatus may further comprise an editing unit obtaining an edited total magnetic anomaly by editing poor quality data based on at least any one of the shown water depth, raw data, signal strength, position of the profile, and shape of the profile; and

According to the present invention, a method of obtaining a quality-enhanced total magnetic anomaly by processing marine magnetic data, using a per-profile data processing scheme and a processing apparatus for the same are provided.

### BRIEF DESCRIPTION OF THE DRAWINGS

The invention description below refers to the accompanying drawings. The patent or application file contains at least one drawing executed in color. Copies of this patent or patent application publication with color drawing(s) will be provided by the Office upon request and payment of the necessary fee.

FIG. 1 shows a track line for acquiring raw marine magnetic data;

FIG. 2 is a flowchart illustrating processing of a marine magnetic data according to an embodiment of the present invention;

FIG. 3 is a view illustrating raw marine magnetic data;

FIG. 4 shows an initial total magnetic anomaly;

FIG. 5 shows an example of per-profile filtered total magnetic anomaly;

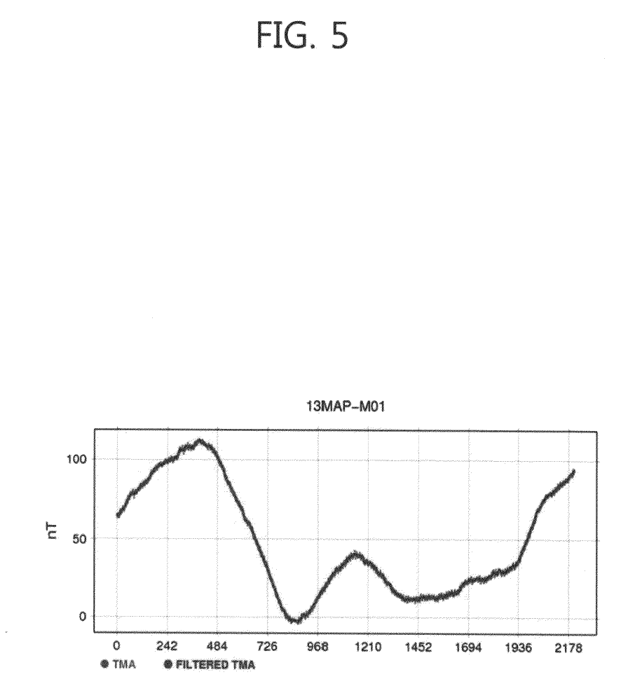

FIG. 6 shows a filtered total magnetic anomaly obtained through filtering;

FIG. 7 shows a reference total magnetic anomaly;

FIG. 8 shows a shifted total magnetic anomaly;

FIG. 9 shows per-profile information related to quality of a total magnetic anomaly so as to rid a poor quality total magnetic anomaly;

FIG. 10 shows a location of a poor quality total magnetic anomaly;

FIG. 11 shows an edited total magnetic anomaly with a poor quality total magnetic anomaly removed;

FIG. 12 shows cross-over errors of a total magnetic anomaly prior to cross-over correction;

FIG. 13 shows cross-over errors of a total magnetic anomaly after cross-over error correction;

FIG. 14 shows a cross-over corrected total magnetic anomaly after cross-over error correction;

FIG. 15 shows combined total magnetic anomaly with other total magnetic anomaly;

FIG. 16 shows cross-over errors of a combined total magnetic anomaly before cross-over error correction;

FIG. 17 shows cross-over errors of a combined total magnetic anomaly after cross-over error correction;

FIG. 18 shows a combined cross-over error corrected total magnetic anomaly after cross-over error correction;

FIG. 19 shows a final total magnetic anomaly; and

FIG. 20 shows an apparatus of processing marine magnetic data according to an embodiment of the present invention.

### DETAILED DESCRIPTION OF AN ILLUSTRATIVE EMBODIMENT

Hereinafter, a method of processing marine magnetic data according to the present invention is described in detail with reference to the accompanying drawings.

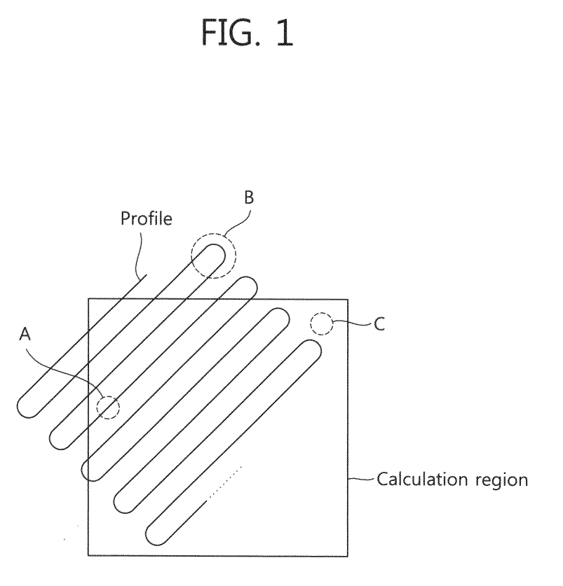

FIG. 1 shows a track line for acquiring raw marine magnetic data. A ship equipped with a magnetometer travels along a zig-zag pathway, i.e., a profile, on the sea. The profile includes a straight line section A and a curved section B connecting to the straight section A. Part in which a travelling pathway is positioned is a measurement region, and the measurement region may differ from a calculation region where a magnetic force should be calculated as shown in the drawings.

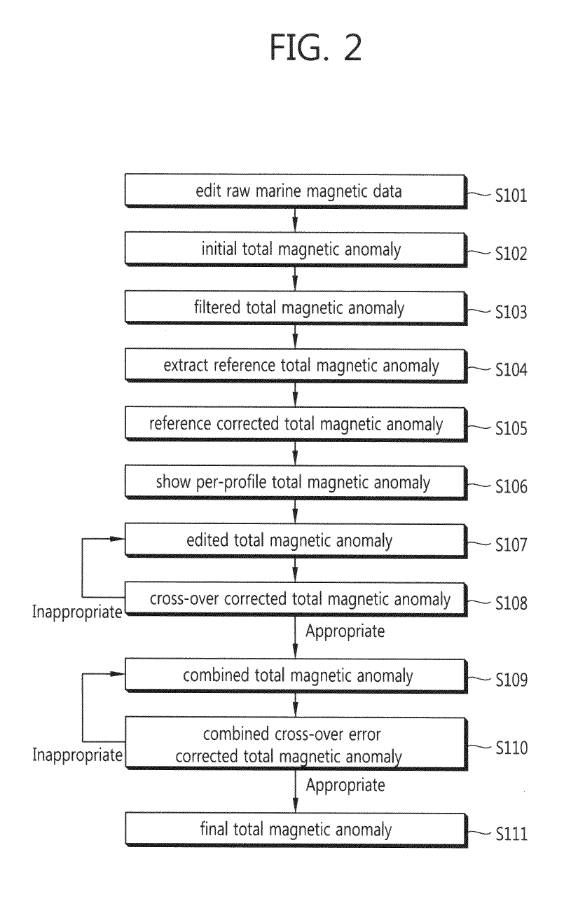

FIG. 2 is a flowchart illustrating processing marine magnetic data according to an embodiment of the present invention. The whole or part of a process described below may be implemented by computer programming.

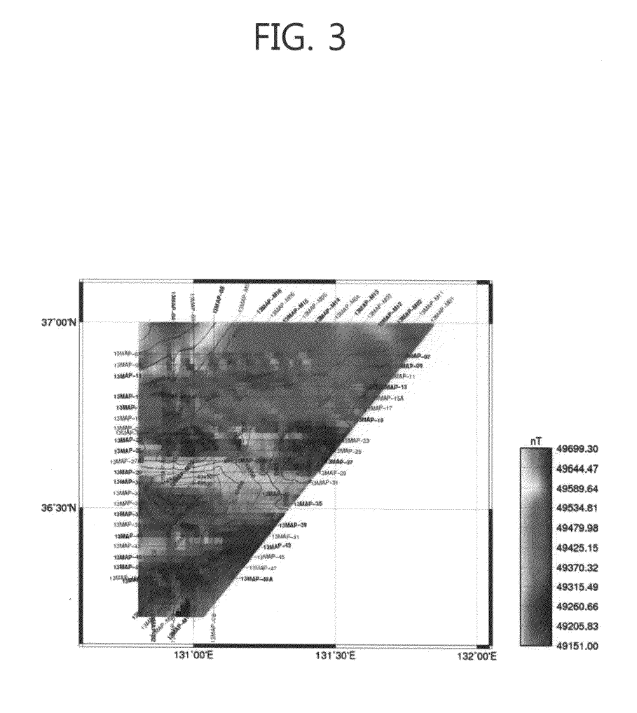

First, as shown in FIG. 3, raw data is edited to obtain raw marine magnetic data (S101). The raw data contains various data, such as latitude, longitude, water depth, magnetic force value, and time, and among them, only data necessary for obtaining a total magnetic anomaly is extracted. The name of the profile, and start and end times of the profile are input, creating per-profile data and a drawing.

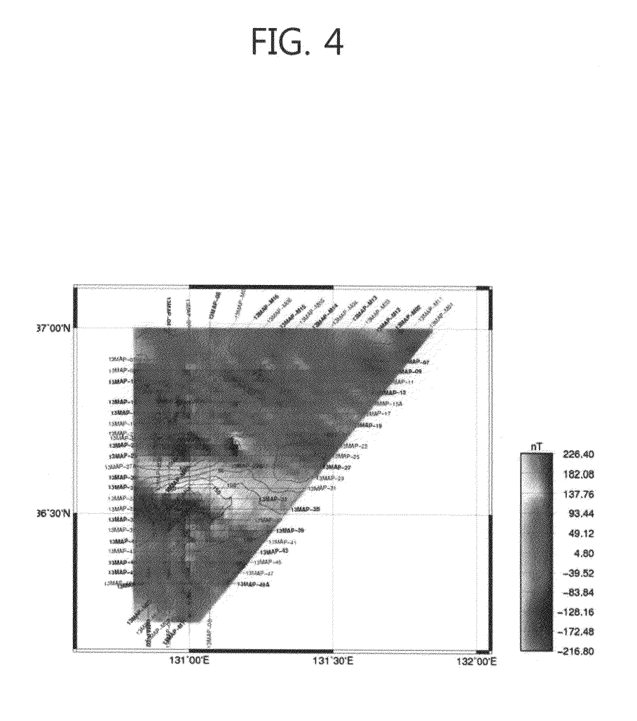

Thereafter, various corrections are made to the raw marine magnetic data, thus producing an initial total magnetic anomaly as shown in FIG. 4 (S102). The corrections are as follows. The measured magnetic data varies over time due to a solar wind from the sun, and this should be corrected. This is referred to as “diurnal correction.” The diurnal correction is conducted using magnetic data from a fixed obverting station. After the diurnal correction, a difference from an IGRF magnetic force is calculated using an IGRF magnetic force equation, thereby obtaining an initial total magnetic anomaly.

Despite such several corrections, complete correction is impossible in reality. Accordingly, the initial total magnetic anomaly still has error factors.

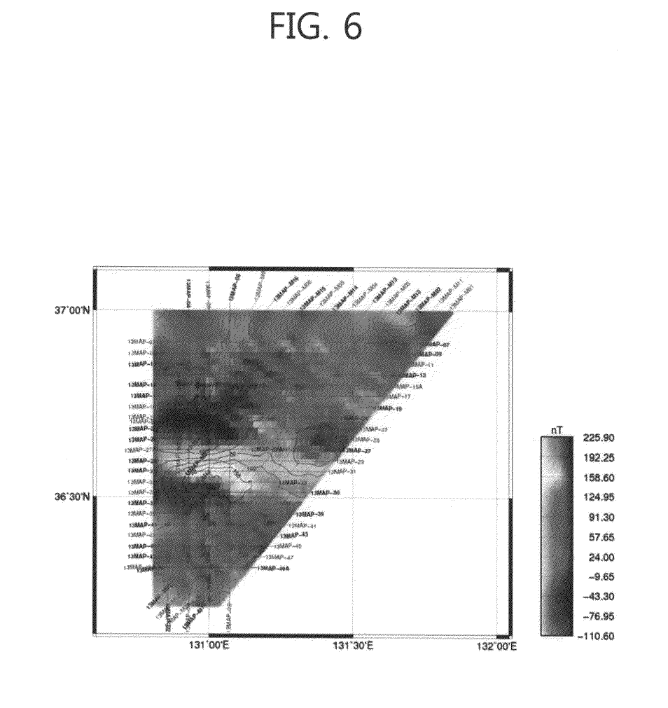

The initial total magnetic anomaly undergoes filtering to obtain a filtered total magnetic anomaly (S103). Filtering may be performed in such a way as removes high-frequency noise distributed using a per-profile moving averaging method. FIG. 6 shows a filtered total magnetic anomaly obtained through filtering, and it can be seen from the view that the total magnetic anomaly range increased by noise is reduced.

A correction method using a reference total magnetic anomaly includes preparing a reference total magnetic anomaly (S104) and obtaining a shifted total magnetic anomaly using the reference total magnetic anomaly (S105).

Per-profile comparison between the total magnetic anomaly and the reference total magnetic anomaly may evaluate data quality and make corrections based on the reference total magnetic anomaly.

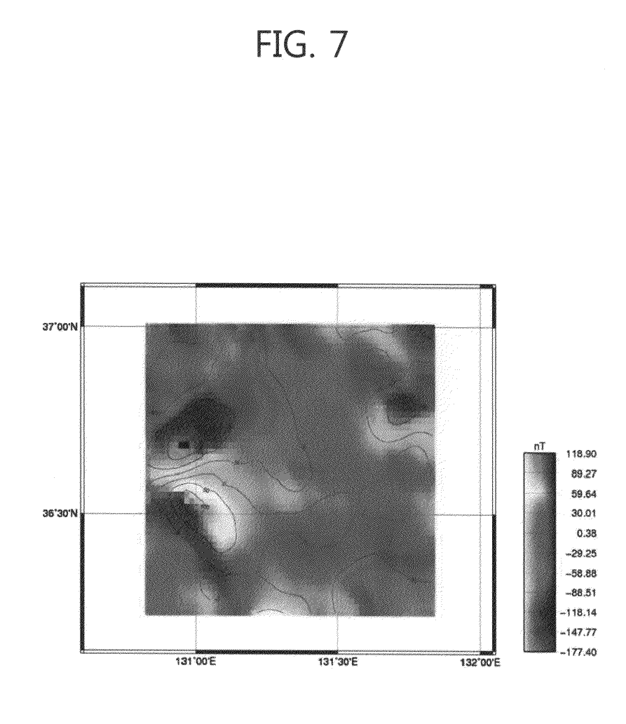

The reference total magnetic anomaly may use data obtained from an airplane or other data or may use data obtained by combining a number of data. Extracting the reference total magnetic anomaly may be conducted independently from calculating the filtered total magnetic anomaly. FIG. 7 shows a reference total magnetic anomaly.

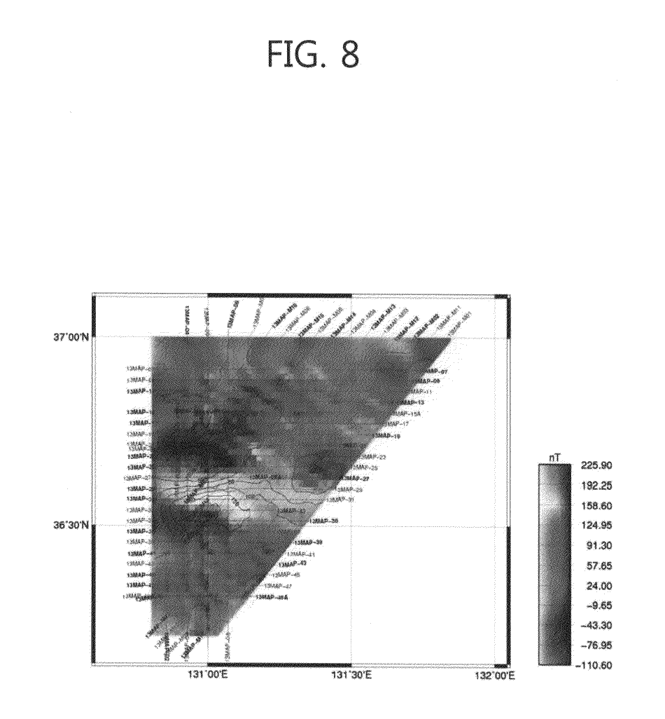

It can be seen that the reference corrected total magnetic anomaly may be acquired by shifting the filtered total magnetic anomaly in consistence with the reference total magnetic anomaly. That is, the per-profile filtered total magnetic anomaly is increased or decreased up to a predetermined value. In some cases, the filtered total magnetic anomaly may immediately serve as the reference corrected total magnetic anomaly without shift. FIG. 8 shows a reference corrected total magnetic anomaly obtained using the reference total magnetic anomaly. In this step, as determined to be unnecessary, shifting might not be carried out, and in such case, the filtered total magnetic anomaly becomes the reference corrected total magnetic anomaly.

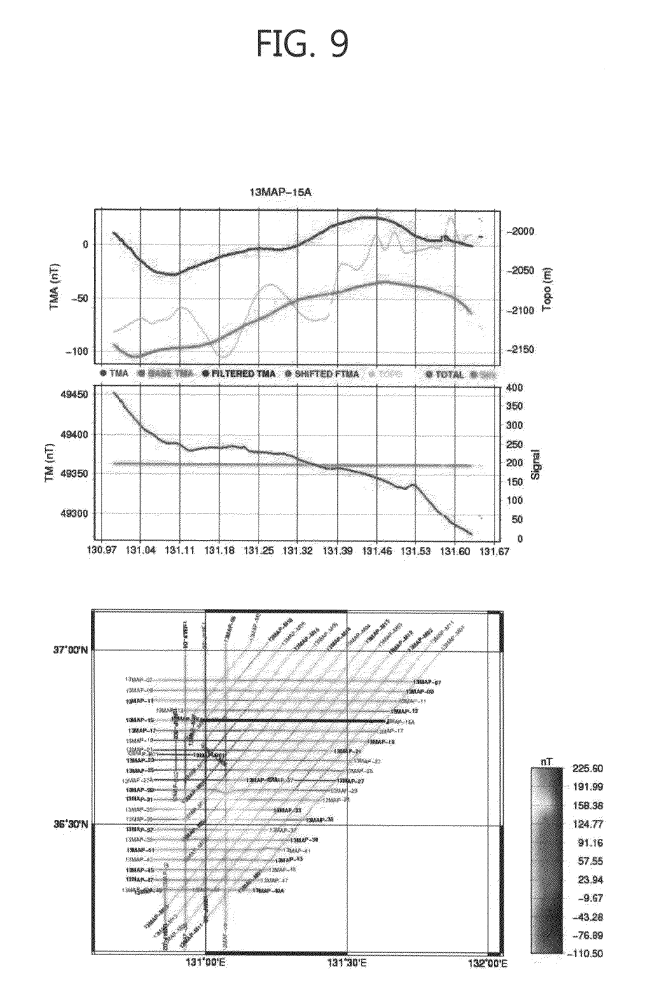

FIG. 9 shows information (water depth, raw data, sensor sensitivity, location of profile, and shape of profile) related to the quality of total magnetic anomaly, as well as the total magnetic anomaly for a specific profile in order to determine whether there is poor quality data (S106). Even after the above-described corrections, unpredictable errors are still contained due to incompleteness of corrections and temporary malfunction of the magnetometer. Such errors-contained poor quality data should be determined and removed by a person who processes data, and for such purposes, the drawing as shown in FIG. 9 is inevitable. However, the existing drawing creating schemes require lots of time and efforts to create a drawing as shown in FIG. 9 and thus omit such process. According to the present invention, a process of creating a drawing is automated. Accordingly, only when &drawing creating automation program is executed, a drawing as shown in FIG. 9 for all profiles may be created within a short time. In this embodiment, 44 profiles are present, and a drawing as shown in FIG. 9 may be autonomously shown for each of the 44 profiles. In the lower view of FIG. 9, among the 44 profiles, the locations of corresponding profiles are shown (in black, bold markings).

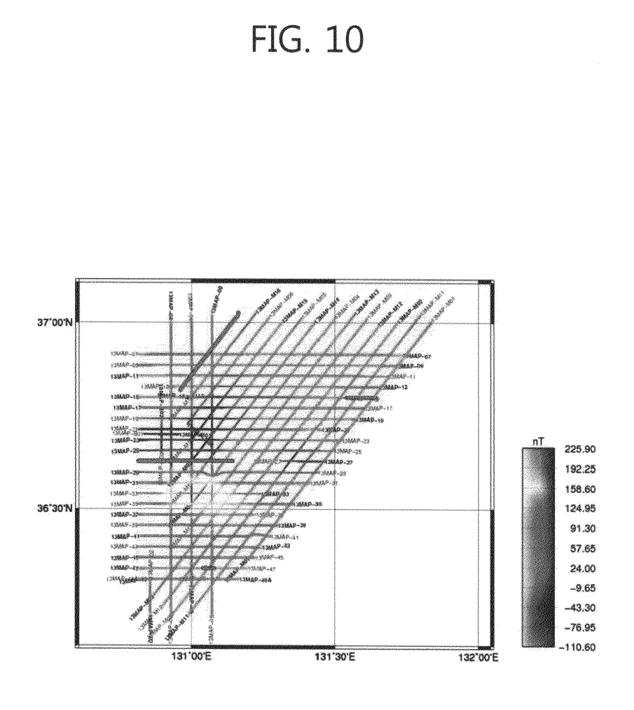

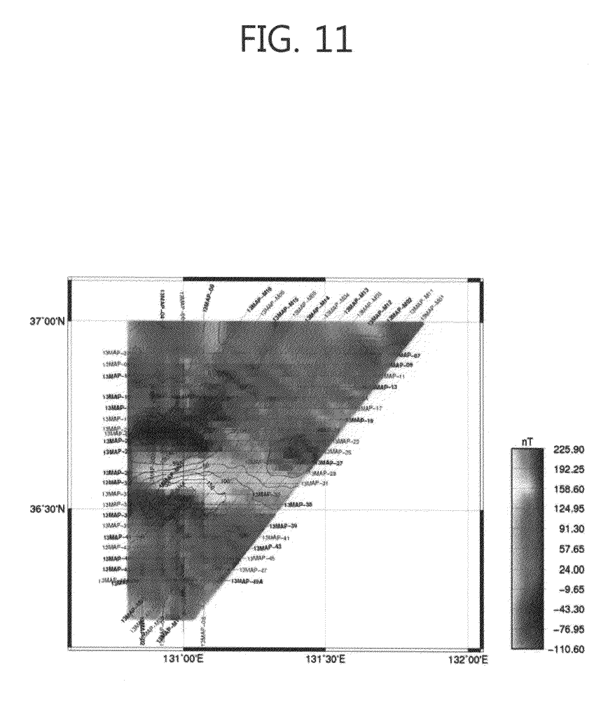

Next, the drawing per profile created as shown in FIG. 9 is referenced to edit a reference corrected total magnetic anomaly that a data processing person determines to be poor quality data (S107). In the instant embodiment, if in the upper view of FIG. 9 the data positioned between longitudes 131.53 degrees and 131.67 degrees is determined to be poor, the range of these longitudes or latitudes and names of profile are entered to a program for editing, thus autonomously riding the portion. FIG. 10 shows an example of displaying data determined to be poor quality(shown in red), and FIG. 11 shows an edited total magnetic anomaly that is a result of removing the poor quality data.

Thereafter, cross-over error correction is performed to obtain a cross-over corrected total magnetic anomaly (S108). Theoretically, when one point is measured while passed over twice or more, the values should be completely consistent with each other. However, even despite going through all of the above-described correction processes, errors generally occur, and this is denoted cross-over errors. In the cross-over error correction, an arithmetic average for two or more different values at cross-over points is obtained, the arithmetic average is defined as a true value, and linear correction is fulfilled on the remaining values between the cross-over points. In case the difference between values at the cross-over points is too large to be appropriate for correction, the total magnetic anomaly is re-edited to thus remove poor quality data. The correction may be then carried out again.

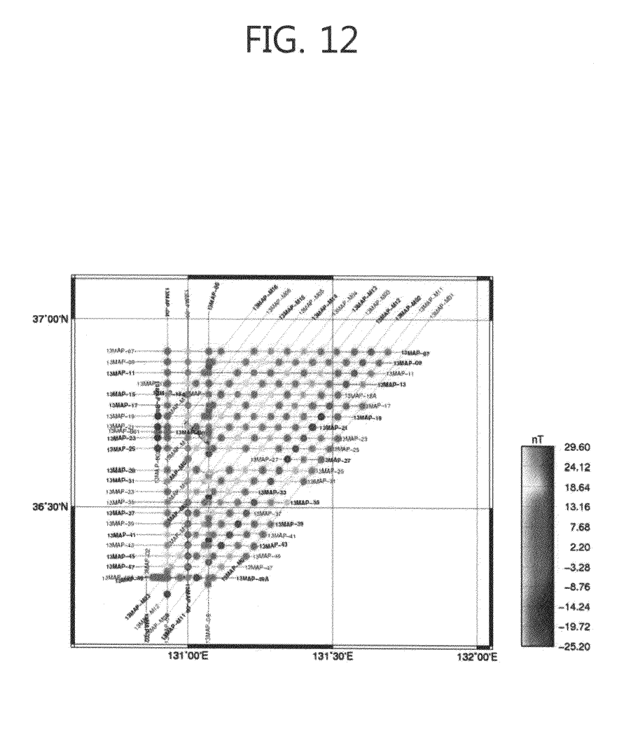

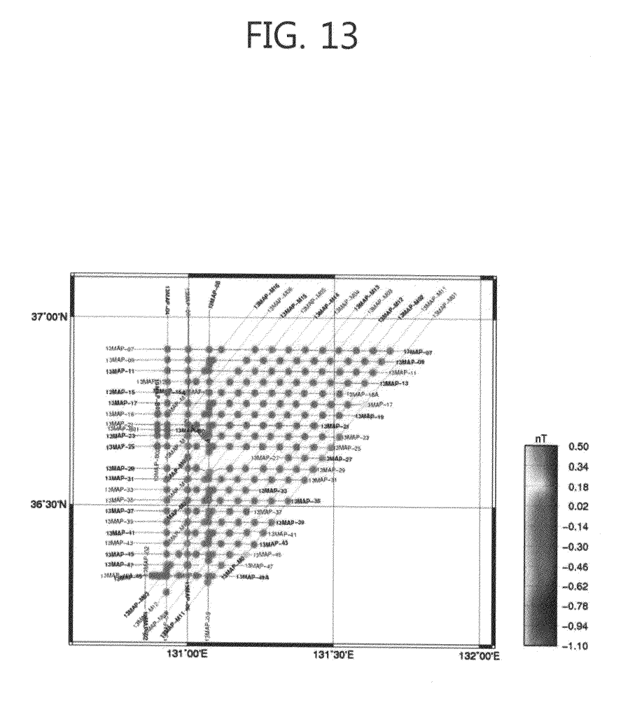

FIG. 12 shows cross-over errors of a total magnetic anomaly before cross-over error correction, and FIG. 13 shows cross-over errors of a total magnetic anomaly after cross-over error correction.

A comparison between FIG. 12 and FIG. 13 shows that the range of a total magnetic anomaly has been significantly reduced by cross-over error correction.

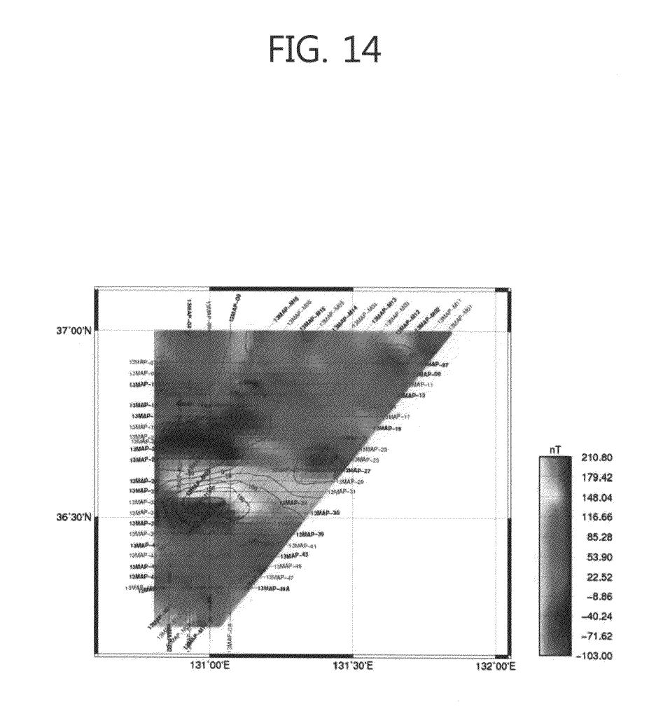

FIG. 14 shows a cross-over corrected total magnetic anomaly reflecting cross-over error correction.

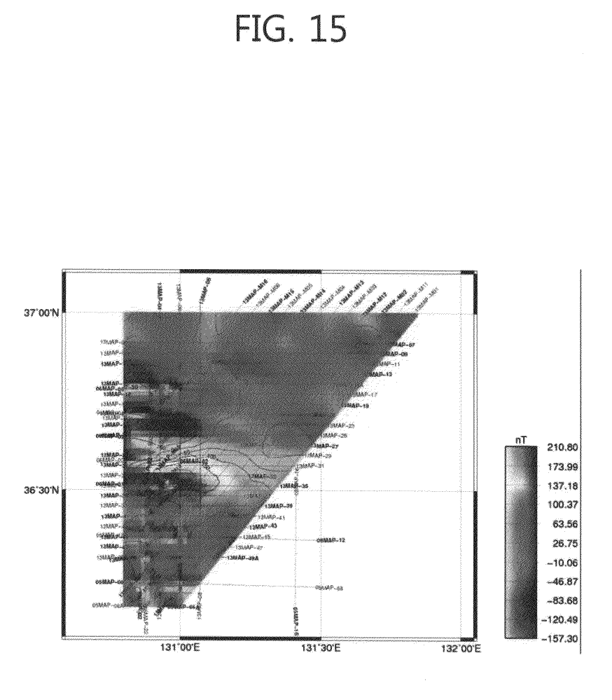

Thereafter, the corrected total magnetic anomaly is combined with other total magnetic anomaly data present in the existing calculation region (S109). By this process, data in the part that has not been measured as shown in FIG. 1(C) may be compensated. FIG. 15 shows a combined total magnetic anomaly.

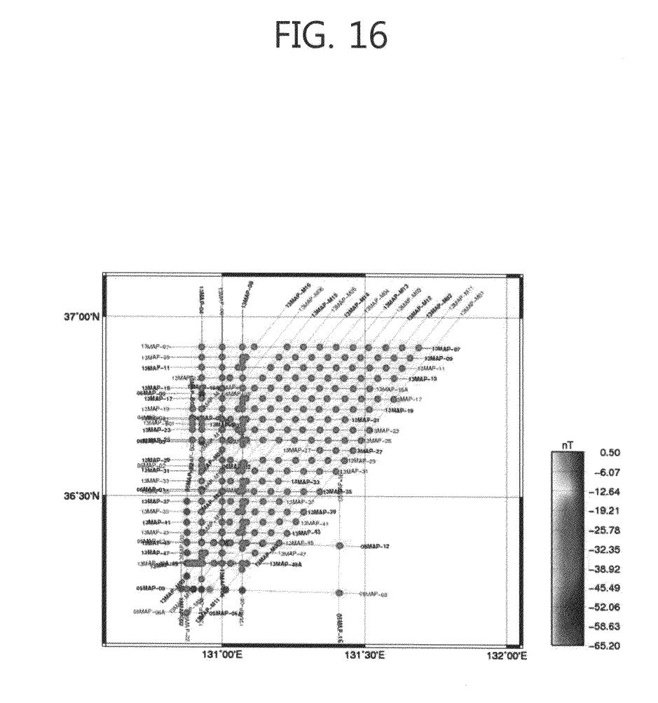

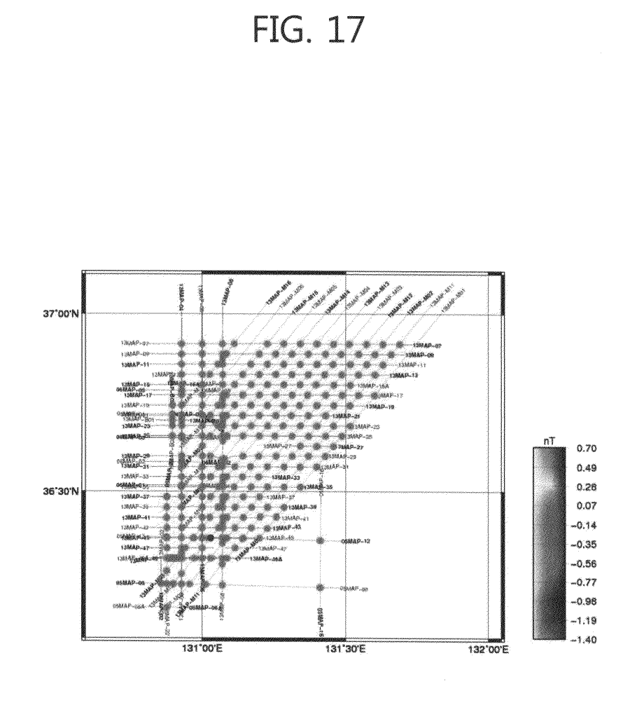

Then, cross-over error correction is conducted in the same way as described above, thus obtaining a combined cross-over corrected total magnetic anomaly (S110). FIG. 16 shows cross-over errors of a combined total magnetic anomaly prior to correction, and FIG. 17 shows cross-over errors of a combined total magnetic anomaly after correction.

It can be seen from FIGS. 16 and 17 that the total magnetic anomaly error range has been decreased by cross-over error correction.

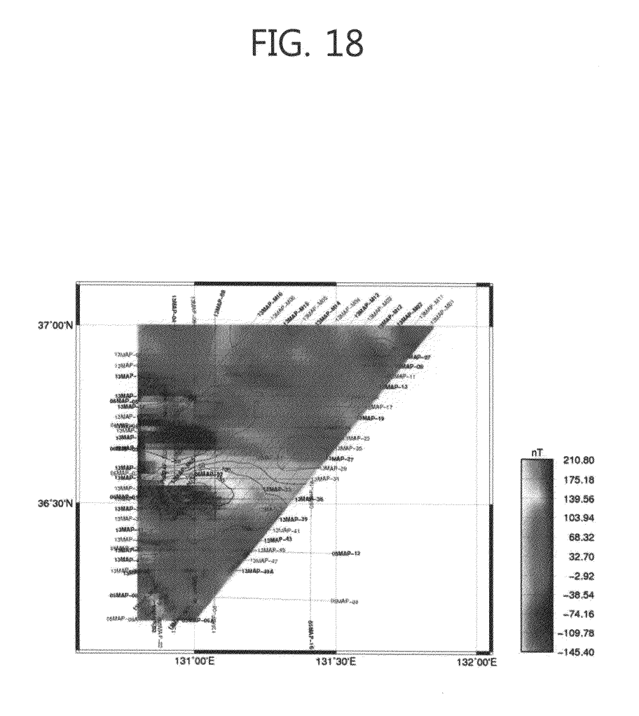

FIG. 18 shows a combined cross-over corrected total magnetic anomaly reflecting cross-over error correction.

Thereafter, grid-gap adjustment is performed to thus yield a final total magnetic anomaly (S111). In the research utilizing magnetic data, short wavelength component-emphasized data or long wavelength component-emphasized data is needed to fit the purposes of research, and upon gridding such data, it may be done by adjusting the grid gap. In other words, such data may be obtained that as the grid gap is rendered to be increased, the long wavelength component is emphasized, and as the grid gap is contrarily rendered to be decreased, the short wavelength component may be emphasized.

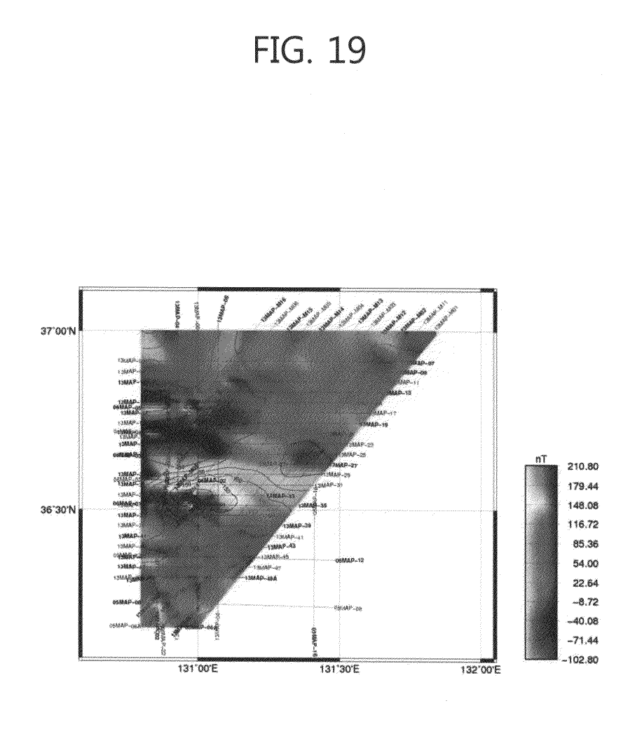

FIG. 19 shows a final total magnetic anomaly.

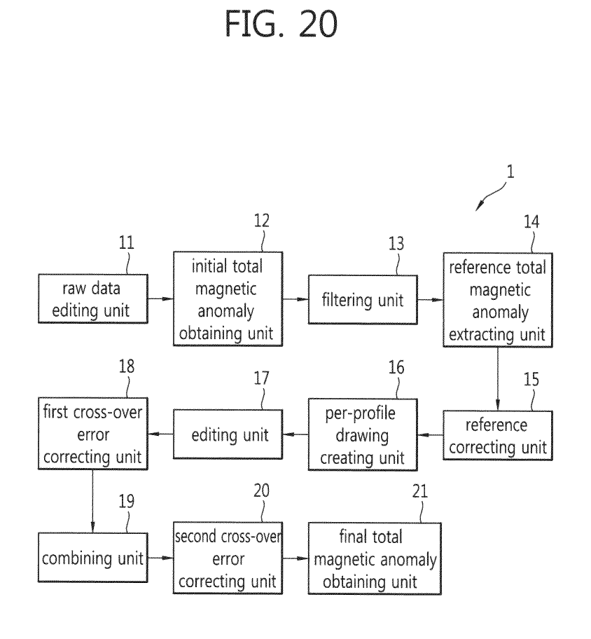

FIG. 20 shows an apparatus of processing a marine magnetic data according to an embodiment of the present invention.

The processing apparatus 1 consists of several modules and includes a raw data editing unit 11, an initial total magnetic anomaly obtaining unit 12, a filtering unit 13, a reference total magnetic anomaly 14, a correcting unit 15, a per-profile drawing creating unit 16, an editing unit 17, a first cross-over error correcting unit 18, a combining unit 19, a second cross-over error correcting unit 20, and a final total magnetic anomaly obtaining unit 21.

Each module in the processing apparatus 1 may be an execution file that has been created in the Fortran programming language, and open source programs, Generic Mapping Tools (GMT) and gawk.exe, may be put to use for creating drawings.

The modules respectively correspond to the processing steps shown in FIG. 2. For example, the filtering unit 13 performs the step S103 of riding high-frequency component noise from the initial total magnetic anomaly to obtain the filtered total magnetic anomaly, and the editing unit 17 performs the step S107 of editing poor quality data from the per-profile total magnetic anomaly to obtain the edited total magnetic anomaly.

Some steps in the process may be omitted, and some order may be changed.

Although embodiments of the present invention have been described, the embodiments are merely an example, and it may be understood by those of ordinary skill in the art that various changes may be made thereto without departing from the scope of the present invention defined by the following claims.

1. A method of processing marine magnetic data, the method comprising:
obtaining a per-profile initial total magnetic anomaly from raw data;
obtaining a filtered total magnetic anomaly by filtering out a high-frequency component from the initial total magnetic anomaly;
obtaining a reference corrected total magnetic anomaly by correcting the filtered total magnetic anomaly with respect to a reference total magnetic anomaly; and
showing a per-profile total magnetic anomaly using the reference corrected total magnetic anomaly.

2. The method of claim 1, wherein showing the per-profile total magnetic anomaly includes showing at least any one of a water depth, raw data, a signal strength, a position of a profile, and a shape of a profile, together with the per-profile total magnetic anomaly.

3. The method of claim 2, further comprising obtaining an edited total magnetic anomaly by editing poor quality data based on at least any one of the shown water depth, raw data, signal strength, position of the profile, and shape of the profile.

4. The method of claim 3, further comprising obtaining a cross-over corrected total magnetic anomaly by performing cross-over error correction on the edited total magnetic anomaly.

5. The method of claim 4, further comprising obtaining a combined cross-over corrected total magnetic anomaly by combining the cross-over corrected total magnetic anomaly with other total magnetic anomaly data and performing cross-over error correction on the combined data.

6. A method of processing marine magnetic data, the method comprising:
preparing for a reference total magnetic anomaly from existing data;
performing reference correction by comparing a total magnetic anomaly obtained from raw data with the reference total magnetic anomaly; and
obtaining a per-profile total magnetic anomaly based on the reference corrected total magnetic anomaly.

7. The method of claim 6, wherein showing the per-profile total magnetic anomaly includes showing at least any one of a water depth, raw data, a signal strength, a position of a profile, and a shape of a profile, together with the per-profile total magnetic anomaly, and the method further comprising:
obtaining an edited total magnetic anomaly by editing poor quality data based on at least any one of the shown water depth, raw data, signal strength, position of the profile, and shape of the profile; and
obtaining a combined total magnetic anomaly by combining the edited total magnetic anomaly with other total magnetic anomaly data.

8. The method of claim 7, further comprising obtaining a final total magnetic anomaly by performing cross-over correction on the combined total magnetic anomaly.

9. An apparatus of processing marine magnetic data, the method comprising:
an initial total magnetic anomaly obtaining unit obtaining a per-profile initial total magnetic anomaly from raw data;
a filtering unit obtaining a filtered total magnetic anomaly by filtering out a high-s frequency component from the initial total magnetic anomaly;
a shifting unit obtaining a reference corrected total magnetic anomaly by correcting the filtered total magnetic anomaly with respect to a reference total magnetic anomaly; and
a per-profile showing unit showing a per-profile total magnetic anomaly using the o reference corrected total magnetic anomaly.

10. The apparatus of claim 9, wherein the per-profile showing unit shows at least any one of a water depth, raw data, a signal strength, a position of a profile, and a shape of a profile, together with the per-profile total magnetic anomaly, and the apparatus further comprising an editing unit obtaining an edited total magnetic anomaly by editing poor quality data based on at least any one of the shown water depth, raw data, signal strength, position of the profile, and shape of the profile.
